(19) United States
(12) Patent Application Publication
(10) Pub. No.: US 2026/0147297 A1
(43) Pub. Date: May 28, 2026

(54) LAMINATED MEMBER, METHOD OF PRODUCING LAMINATED MEMBER, AND ELECTROPHOTOGRAPHIC MEMBER

(71) Applicant: CANON KABUSHIKI KAISHA, Tokyo (JP)

(72) Inventor: YASUHIRO MIYAHARA, Tokyo (JP)

(21) Appl. No.: 19/382,397

(22) Filed: Nov. 7, 2025

(30) Foreign Application Priority Data
Nov. 27, 2024 (JP) 2024-206477

(51) Int. Cl. G03G 15/20

(52) U.S. Cl. CPC G03G 15/2057; G03G 15/2064; G03G 2215/2048

(57) ABSTRACT

Provided are a laminated member and a method of producing the same, the laminated member including a base layer, an adhesion layer, and a surface layer laminated in this order, wherein the base layer has a lightness of 15 or less, wherein the surface layer has a visible light transmittance of 60% or more, and wherein a bubble is present between the surface layer and the base layer, and the bubble forms a mark portion visually recognizable from a surface of the laminated member.

### BACKGROUND

### Field of the Technology

The present disclosure relates to a laminated member, a method of producing a laminated member, and a member of an electrophotographic image forming apparatus.

### Description of the Related Art

An electrophotographic image forming apparatus is equipped with an electrophotographic member in which a rubber layer is coated with a fluororesin, such as a roller (e.g., a fixing roller) or a belt (e.g., a fixing belt).

In order to individually manage such electrophotographic member, it is preferred that a mark portion (e.g., a character string such as a serial number) be provided to the electrophotographic member (hereinafter also referred to as “marking”). In addition, the mark portion is required not only to ensure visibility of a lot stamp or the like, but also to be high-resolution marking in order to read a stamp with a large amount of information, such as a two-dimensional barcode.

As a method of performing marking on such electrophotographic member, in Japanese Patent Laid-Open No. 2005-338350, there is a proposal of a method including performing marking on a rubber layer and then coating the rubber layer with a fluororesin. Specifically, the marking is performed by irradiating a red iron oxide-colored rubber layer with laser light. Consequently, the resultant mark portion becomes black, and the mark portion is thus easily visible relative to the surrounding bright red iron oxide color.

In addition, in Japanese Patent Laid-Open No. 2016-161929, there is a proposal of a configuration in which a deep groove is formed in an elastic layer, and an adhesion layer is poured into the groove to provide a lightness difference between a mark portion and the surroundings, to thereby make the mark portion easily visible.

However, the inventions described in Japanese Patent Laid-Open No. 2005-338350 and Japanese Patent Laid-Open No. 2016-161929 have the following problems.

When a mark portion is provided on an elastic layer as disclosed in Japanese Patent Laid-Open No. 2005-338350, no contrast is produced between a stamped portion and a non-stamped portion in a case of a dark-colored elastic layer with low lightness, and there has been room for improvement in visibility.

When deep irregularities are formed, and an adhesion layer is poured thereinto as disclosed in Japanese Patent Laid-Open No. 2016-161929, unless the width of a recess is large to some extent, the adhesion layer does not flow into the recess, and hence the width of the recess needs to be increased to a certain extent. Thus, there has been room for improvement in resolution of the mark portion to be formed.

### SUMMARY

The present disclosure has been made in view of the above-mentioned problems.

That is, according to one aspect of the present disclosure, there is provided a laminated member including a base layer, an adhesion layer, and a surface layer laminated in this order, wherein the base layer has a lightness of 15 or less, wherein the surface layer has a visible light transmittance of 60% or more, and wherein a bubble is present between the surface layer and the base layer, and the bubble forms a mark portion visually recognizable from a surface of the laminated member.

In addition, according to another aspect of the present disclosure, there is provided a method of producing a laminated member having a mark portion visually recognizable from a surface, the method including irradiating a laminated member before processing, in which a base layer having a lightness of 15 or less, an adhesion layer, and a surface layer having a visible light transmittance of 60% or more are laminated in this order, with laser light from a surface layer side to generate a bubble between the base layer and the surface layer, to thereby form the mark portion.

In addition, according to yet another aspect of the present disclosure, there is provided an electrophotographic member having a cylindrical shape, the electrophotographic member including a laminated structure in which an elastic layer, an adhesion layer, and a surface layer are laminated in this order, wherein the elastic layer has a lightness of 15 or less, wherein the surface layer has a visible light transmittance of 60% or more, and wherein a bubble is present between the surface layer and the elastic layer, and the bubble forms a mark portion visually recognizable from a surface of the laminated structure.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view of an image forming apparatus according to the present disclosure.

FIG. 2 is a schematic cross-sectional view of a fixing device according to the present disclosure.

FIG. 3 is a schematic view of a fixing belt according to the present disclosure.

FIG. 4A is a schematic view of the fixing belt according to the present disclosure.

FIG. 4B is a schematic view of the fixing belt according to the present disclosure.

FIG. 4C is a schematic view of the fixing belt according to the present disclosure.

FIG. 5 is a schematic view of a coating device using a ring coating method in a fixing belt elastic layer forming step according to the present disclosure.

FIG. 6A is a schematic view for illustrating steps from rubber coating to adhesive application in a fixing belt production process according to the present disclosure.

FIG. 6B is a schematic view for illustrating steps from tube insertion to cutting into a product length in the fixing belt production process according to the present disclosure.

FIG. 7 is a perspective view of a jig for evaluating pressure resistance durability of a mark portion of the fixing belt according to the present disclosure.

### DESCRIPTION OF THE EMBODIMENTS

A laminated member according to the present disclosure is a laminated member including a base layer, an adhesion layer, and a surface layer laminated in this order. In the laminated member according to the present disclosure, the base layer has a lightness of 15 or less, and the surface layer has a visible light transmittance of 60% or more. Further, in the laminated member according to the present disclosure, a bubble is present between the surface layer and the base layer, and the bubble forms a mark portion visually recognizable from a surface of the laminated member.

Although an electrophotographic member, specifically, a fixing belt used in a fixing device mounted in an electrophotographic image forming apparatus is described in detail below as an example of the laminated member according to the present disclosure, the present disclosure is not limited to such example. In addition, various configurations may be replaced with other configurations within the scope of the spirit of the present disclosure.

First, the overall configuration of an electrophotographic image forming apparatus (hereinafter simply referred to as “image forming apparatus”) is described.

### (1) Image Forming Apparatus

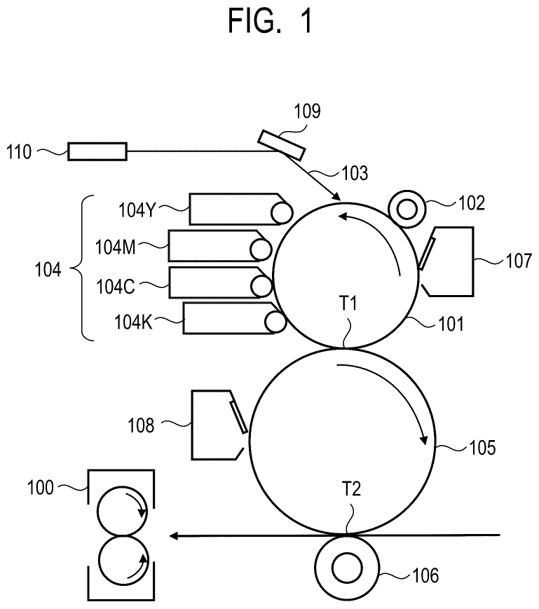

FIG. 1 is a schematic cross-sectional view of the image forming apparatus. A photosensitive member (image bearing member) 101 is rotationally driven in a direction indicated by the arrow at a predetermined process speed (peripheral speed). As a device for forming a toner image using an electrophotographic process, a charging device 102, a laser light source 110, a laser optical system 109, and a developing device 104 (104Y to 104K) are arranged around the photosensitive member 101. In addition, a cleaning device 107 is arranged around the photosensitive member 101.

Next, a flow of the electrophotographic process is described.

The photosensitive member 101 is uniformly charged to have predetermined polarity (negative polarity in this example) by a charging roller 102, which is the charging device. Next, the charged photosensitive member 101 is irradiated (subjected to image exposure treatment) with laser light 103 emitted from the laser light source 110 through the laser optical system 109 based on input image information (information on an original image).

The laser light source 110 emits the laser light 103 modulated (on/off) based on the image information to subject the photosensitive member 101 to scanning exposure. As a result, an electrostatic latent image corresponding to the image information is formed on the photosensitive member 101. The electrostatic latent image formed on the photosensitive member 101 is then formed into a visible image by the developing device 104 using toner.

Specifically, a yellow toner image is formed by the developing device 104Y, and the yellow toner image is primarily transferred from the photosensitive member 101 to an intermediate transfer member 105 at a primary transfer portion T1. After the primary transfer, toner remaining on the photosensitive member 101 is cleaned by the cleaning device 107.

A process cycle of charging, exposure, development, primary transfer, and cleaning as described above is similarly repeated to form a magenta toner image (with the developing device 104M operating), a cyan toner image (with the developing device 104C operating), and a black toner image (with the developing device 104K operating).

In this manner, the toner images of four colors sequentially transferred in a superimposed manner onto the intermediate transfer member 105 are collectively secondarily transferred to a recording material at a secondary transfer portion T2. At this time, a positive voltage is applied to the transfer roller 106 arranged to face the intermediate transfer member 105. After the secondary transfer, toner remaining on the intermediate transfer member 105 is cleaned by a cleaning device 108.

The cleaning device 108 is configured to be contactable with and separable from the intermediate transfer member 105, and to be in contact with the intermediate transfer member 105 only when the intermediate transfer member 105 is cleaned. In addition, the transfer roller 106 is configured to be contactable with and separable from the intermediate transfer member 105, and to be in contact with the intermediate transfer member 105 only during the secondary transfer.

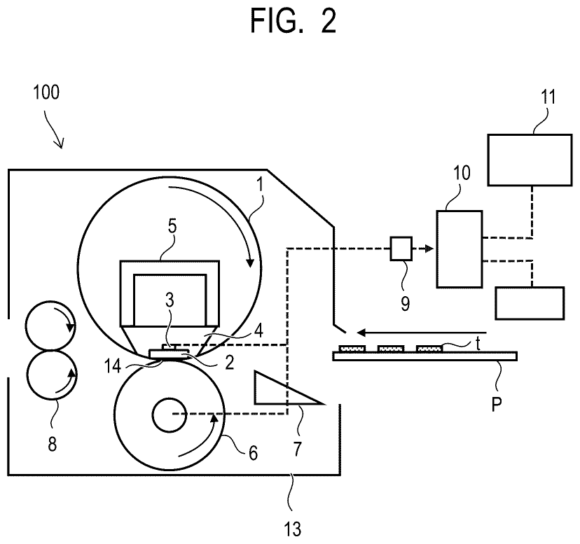

Then, the recording material having been passed through the secondary transfer portion T2 receives heat and pressure applied by a fixing belt 1 and a pressure roller 6 (FIG. 2) of a fixing device (image heating device) 100, and is subjected to fixing treatment (image heating treatment) of a toner image “t” (FIG. 2) borne thereon. Then, the recording material having been subjected to the fixing treatment is discharged to the outside of the device, and a series of image forming operations is completed.

In this example, the fixing belt 1 provided in the fixing device 100 corresponds to the electrophotographic member according to the present disclosure.

### (2) Fixing Device

FIG. 2 is a schematic cross-sectional view of the fixing device 100.

The endless fixing belt (fixing rotary member) 1 is used as a cylindrical electrophotographic member in the present disclosure.

The pressure roller (rotary pressure member) 6 is a member for forming a nip portion 14 with the fixing belt 1. The pressure roller 6 has a multilayer structure in which a silicone rubber elastic layer having a thickness of about 3 mm and a tetrafluoroethylene-perfluoro (alkyl vinyl ether) copolymer (PFA) resin tube having a thickness of about 50 μm are sequentially stacked on a metal core formed from a metal. Both end portions in the longitudinal direction of the metal core of the pressure roller 6 are rotatably supported by a device frame 13.

When the pressure roller 6 is rotationally driven in the direction of the arrow by a drive motor, the fixing belt 1, which is pressed against the pressure roller 6 to be in contact with the pressure roller 6, is driven to rotate following the pressure roller 6. In addition, a lubricant is applied to an inner surface of the fixing belt 1, ensuring slidability between the inner surface and a holder 4.

A fixing heater 2 is a member for heating a recording material P via the fixing belt 1. The fixing heater 2 has an alumina substrate and a resistance heating element that is formed by applying, in a film shape with a thickness of about 10 μm, a conductive paste containing a silver-palladium alloy onto the alumina substrate by a screen printing method. The fixing heater 2 is further configured as a ceramic heater obtained by subjecting the resistance heating element to glass coating with pressure-resistant glass. In addition, the fixing heater 2 also has a function as a pressing member that presses the fixing belt 1 toward the pressure roller 6.

The holder 4 is a member that holds the fixing heater 2 and is formed from a liquid crystal polymer resin with high heat resistance. A metal stay 5 is a member that backs up the holder 4, and both end portions in the longitudinal direction thereof are biased toward the pressure roller 6 by a pressing mechanism with a total pressure of, for example, 290 N (29 kgf).

A temperature sensor 3 is a member that detects the temperature of the fixing heater 2, and is connected to a control unit (CPU) 10 via an A/D converter 9. The temperature sensor 3 outputs a temperature detection signal to the control unit 10. Meanwhile, the control unit 10 is configured to sample an output from the temperature sensor 3 at a predetermined cycle, and reflects temperature information thus obtained in temperature control. That is, the control unit 10 serves to control energization of the fixing heater 2 by a heater drive circuit 11 based on the output from the temperature sensor 3, so that the temperature of the fixing heater 2 reaches a target temperature.

A guide 7 is a member that guides the recording material P toward the nip portion 14. A pair of conveying rollers 8 is a member that conveys the recording material P immediately after the fixing processing.

### (2-1) Fixing Belt

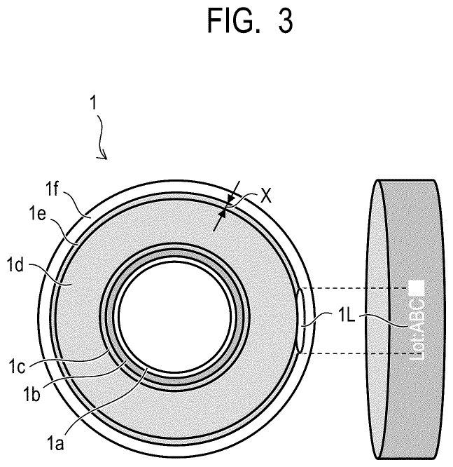

FIG. 3 is a schematic view of the fixing belt 1.

The fixing belt 1 is the cylindrical electrophotographic member according to the present disclosure and has a laminated structure in which an elastic layer 1d, an adhesion layer 1e, and a surface layer 1f are laminated in the stated order. The elastic layer 1d is a layer corresponding to the base layer in the laminated member according to the present disclosure.

The fixing belt 1 also has a cylindrical base 1b and an inner surface sliding layer 1a arranged on an inner circumferential surface of the cylindrical base 1b. The inner surface sliding layer 1a is provided to improve slidability between the fixing belt 1 and the fixing heater 2. When there is no particular need to improve slidability, the inner surface sliding layer 1a may be omitted.

The elastic layer (hereinafter also referred to as “rubber layer” or “silicone rubber elastic layer”) 1d is arranged above the outer circumferential surface of the cylindrical base 1b via a primer layer 1c.

The surface layer (hereinafter also referred to as “fluororesin layer” or “release layer”) 1f is arranged above the outer circumferential surface of the rubber layer 1d via the adhesion layer 1e of a white color.

In the fixing belt 1, a bubble is present between the surface layer 1f and the rubber layer 1d, and the bubble forms a mark portion 1L visually recognizable from a surface of the electrophotographic member (fixing belt 1) as the laminated member. The mark portion 1L is a letter, a symbol, a two-dimensional barcode, or the like for managing the fixing belt 1. Specifically, in this example, “Lot: ABC” and a two-dimensional barcode (DataMatrix) thereof are stamped.

The mark portion 1L is not limited to the above-mentioned examples, as long as the purpose thereof is to convey any intention or instruction to an operator or an assembler, such as an arrow indicating an assembling direction or an illustration indicating an assembling procedure during manufacture or assembly, in addition to a production number.

Each layer of the fixing belt 1 is described in detail below.

### (2-1-1) Cylindrical Base

A material for the cylindrical base 1b is not particularly limited, and a known material to be used as the base layer of a fixing member such as a film for fixing may be adopted. For example, metals and alloys, such as aluminum, iron, stainless steel, and nickel, and heat-resistant resins such as polyimide are each used as the material for the cylindrical base 1b. Although the thickness of the layer is not particularly limited, the thickness is preferably set to 20 μm or more and 100 μm or less from the viewpoints of, for example, the strength, flexibility, and heat capacity thereof.

The outer surface of the cylindrical base 1b may be subjected to surface treatment for imparting an adhesive property with the elastic layer 1d. Physical treatment, such as blasting treatment, lapping treatment, and polishing, and chemical treatment, such as oxidation treatment, coupling agent treatment, and primer treatment, may be used alone or in combination thereof as the surface treatment.

When the elastic layer 1d is arranged on the surface of the cylindrical base 1b, the surface of the cylindrical base 1b is preferably subjected to primer treatment for improving an adhesive property between the cylindrical base 1b and the elastic layer 1d. A primer to be used in the primer treatment is, for example, a paint obtained by appropriately blending and dispersing a silane coupling agent, a silicone polymer, hydrogenated methylsiloxane, an alkoxysilane, a reaction-accelerating catalyst, and a colorant such as red oxide in an organic solvent. The primer may be appropriately selected in accordance with the material for the cylindrical base 1b, the kind of the elastic layer 1d, or the form of the crosslinking reaction of the rubber. In particular, when the elastic layer 1d contains a large amount of an unsaturated aliphatic group, a primer containing a hydrosilyl group is suitably used for imparting the adhesive property through its reaction with the unsaturated aliphatic group. When the elastic layer 1d contains a large amount of a hydrosilyl group, a primer containing an unsaturated aliphatic group is suitably used.

In addition to the foregoing, a primer containing an alkoxy group is also available as the primer. A commercial product may be used as the primer. In addition, the primer treatment includes a step of applying the primer to the outer surface (surface bonded to the elastic layer) of the cylindrical base 1b, followed by its drying or calcination.

### (2-1-2) Inner Surface Sliding Layer

As the inner surface sliding layer 1a, resins having high durability and high heat resistance, such as a polyimide resin, a polyamide-imide resin, and a polyether ether ketone resin, are suitable. In particular, from the aspects of ease of production, heat resistance, elastic modulus, strength, and the like, a polyimide resin is preferable as the inner surface sliding layer 1a. The polyimide resin is formed from a polyimide precursor solution obtained by reacting, in an organic polar solvent, an aromatic tetracarboxylic dianhydride or a derivative thereof and an aromatic diamine in substantially equimolar amounts. Specifically, the polyimide resin may be formed by coating an inner surface of the cylindrical base 1b with the polyimide precursor solution, followed by drying and heating to cause a dehydration ring-closing reaction.

A ring coating method may be adopted as a coating method. The cylindrical base 1b having the coated inner surface is left to dry in a circulating hot air oven at 60° C. for 30 minutes, and then left to be fired in a circulating hot air oven at from 200° C. to 240° C., a temperature range that does not lower fatigue strength of the cylindrical base, for 10 to 60 minutes, for example. As a result, a polyimide inner surface sliding layer can be formed through the dehydration ring-closing reaction.

### (2-1-3-1) Elastic Layer

The elastic layer 1d is a layer for imparting flexibility to the electrophotographic member in order to ensure a fixing nip in a heat fixing device. When the electrophotographic member is used as a heating member to be brought into contact with toner on a sheet, the elastic layer 1d also functions as a layer for imparting flexibility allowing a surface of the heating member to follow irregularities of the sheet.

The elastic layer 1d contains a rubber as a matrix and particles dispersed in the rubber. More specifically, the elastic layer 1d contains a rubber and thermally conductive particles, and is formed of a cured product obtained by curing a composition that contains at least raw materials (a base polymer, a cross-linking agent, and the like) for the rubber, and the thermally conductive particles.

As the composition for forming the elastic layer 1d, a silicone rubber composition is preferably used. Most silicone rubber compositions are liquid, and hence a thermally conductive filler is easily dispersed, and the elasticity of the elastic layer 1d to be produced is easily adjusted by adjusting the cross-linking degree thereof in accordance with the type and addition amount of the thermally conductive particles.

The rubber serving as the matrix has a function to exhibit elasticity in the elastic layer 1d. The rubber serving as the matrix preferably contains a silicone rubber from the viewpoint of exhibiting the function of the elastic layer 1d described above. The silicone rubber is preferred because the silicone rubber has high heat resistance capable of maintaining flexibility even in an environment in which a non-sheet-passing region reaches a high temperature of about 240° C. A cured product of an addition-curable liquid silicone rubber described later may be used as the silicone rubber, for example.

The liquid silicone rubber composition usually contains the following components (a) to (d):
component (a): a linear organopolysiloxane having an unsaturated aliphatic group;
component (b): an organopolysiloxane having active hydrogen bonded to silicon;
component (c): a catalyst; and
component (d): a thermally conductive filler.

Each component is described below.

<Component (a)>

The linear organopolysiloxane having an unsaturated aliphatic group is an organopolysiloxane having an unsaturated aliphatic group such as a vinyl group, and examples thereof include the following structural formula (1) and structural formula (2) each having a structure in which siloxane bonds are linearly connected.

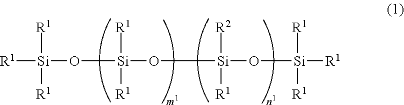

In the structural formula (1), m¹ represents an integer of 0 or more and n¹ represents an integer of 3 or more. In addition, in the structural formula (1), R¹s each independently represent an unsubstituted or substituted monovalent hydrocarbon group free of any unsaturated aliphatic group, provided that at least one of the R¹s represents a methyl group, and R²s each independently represent an unsaturated aliphatic group.

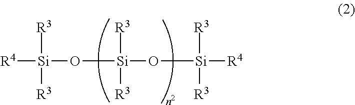

In the structural formula (2), n² represents a positive integer, and R³s each independently represent an unsubstituted or substituted monovalent hydrocarbon group free of any unsaturated aliphatic group, provided that at least one of the R³s represents a methyl group, and R⁴s each independently represent an unsaturated aliphatic group.

In the structural formula (1) and the structural formula (2), examples of the unsubstituted or substituted monovalent hydrocarbon group free of any unsaturated aliphatic group that may be represented by each of R¹ and R³ may include the following groups.

Examples of the unsubstituted hydrocarbon group include alkyl groups, such as a methyl group, an ethyl group, a propyl group, a butyl group, a pentyl group, and a hexyl group, and aryl groups such as a phenyl group.

Examples of the substituted hydrocarbon group include substituted alkyl groups, such as a chloromethyl group, a 3-chloropropyl group, a 3,3,3-trifluoropropyl group, a 3-cyanopropyl group, and a 3-methoxypropyl group.

The organopolysiloxane represented by each of the structural formula (1) and the structural formula (2) has at least one methyl group directly bonded to a silicon atom forming the chain structure. However, it is preferred that 50% or more each of R¹s and R³s represent methyl groups, and it is more preferred that all of R¹s and R³s represent methyl groups because the organopolysiloxane is easy to synthesize and handle.

In addition, in the structural formula (1) and the structural formula (2), examples of the unsaturated aliphatic group that may be represented by each of R² and R⁴ may include the following groups. That is, examples of the unsaturated aliphatic group may include a vinyl group, an allyl group, a 3-butenyl group, a 4-pentenyl group, and a 5-hexenyl group. It is preferred that R² and R⁴ each represent a vinyl group out of those groups because the organopolysiloxane is easy to synthesize and handle, and is inexpensive, and its cross-linking reaction is easily performed.

The viscosity of the component (a) is preferably 1,000 mm²/s or more and 20,000 mm²/s or less from the viewpoint of moldability. When the viscosity is lower than 1,000 mm²/s, adjustment to hardness required for the elastic layer becomes difficult, and when the viscosity is higher than 20,000 mm²/s, surface properties after coating may deteriorate. The viscosity (kinematic viscosity) may be measured with a capillary viscometer, a rotational viscometer, or the like based on JIS Z 8803:2011.

The blending amount of the component (a) is preferably 55 vol % or more from the viewpoint of durability and 70 vol % or less from the viewpoint of thermal conductivity with respect to the liquid silicone rubber composition used to form the elastic layer 1d.

<Component (b)>

The organopolysiloxane having active hydrogen bonded to silicon functions as a cross-linking agent that reacts with the unsaturated aliphatic group of the component (a) by the action of a catalyst to form a cured silicone rubber.

As the component (b), any organopolysiloxane may be used as long as the organopolysiloxane has a Si—H bond. In particular, from the viewpoint of reactivity with the unsaturated aliphatic group of the component (a), an organopolysiloxane in which the average number of hydrogen atoms bonded to a silicon atom in one molecule is 3 or more is preferably used.

Specific examples of the component (b) include a linear organopolysiloxane represented by the following structural formula (3) and a cyclic organopolysiloxane represented by the following structural formula (4).

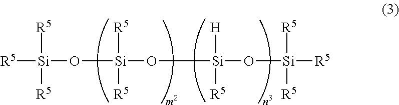

In the structural formula (3), m² represents an integer of 0 or more, n³ represents an integer of 3 or more, and R⁵s each independently represent an unsubstituted or substituted monovalent hydrocarbon group free of any unsaturated aliphatic group.

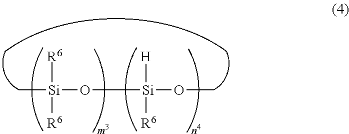

In the structural formula (4), m³ represents an integer of 0 or more, n⁴ represents an integer of 3 or more, and R⁶s each independently represent an unsubstituted or substituted monovalent hydrocarbon group free of any unsaturated aliphatic group.

Examples of the unsubstituted or substituted monovalent hydrocarbon group free of any unsaturated aliphatic group that may be represented by each of R⁵ and R⁶ in the structural formula (3) and the structural formula (4) may include the same groups as those for R¹ in the structural formula (1) described above. It is preferred that 50% or more each of R⁵s and R⁶s represent methyl groups out of those groups, and it is more preferred that all of R⁵s and R⁶s represent methyl groups because the organopolysiloxane is easy to synthesize and handle, and easily exhibits excellent heat resistance.

<Component (c)>

An example of the catalyst used to form the silicone rubber may be a hydrosilylation catalyst for accelerating a curing reaction. As the hydrosilylation catalyst, a known substance, such as a platinum compound or a rhodium compound, may be used, for example. The blending amount of the catalyst may be appropriately set and is not particularly limited.

<Component (d)>

The thermally conductive filler is selected in consideration of the thermal conductivity, specific heat capacity, density, particle diameter, relative permittivity, and the like thereof. The thermally conductive filler is used for the purpose of improving heat transfer characteristics of an inorganic substance, in particular, a metal, a metal compound, and the like, and preferably contains, as a main component, metal silicon, silicon carbide, or carbon fibers in which the content of ionic impurities (e.g., Na⁺) in the filler is low from the viewpoint of heat resistance of the elastic layer 1d. In particular, when a step of subjecting a release layer 1f described later to heat treatment at a temperature equal to or higher than the melting temperature thereof to improve a thermal conductivity in the thickness direction and a degree of crystallinity is executed, heat resistance becomes important.

When the component (d) is incorporated in this manner, the silicone rubber is colored, and a lightness (L*) of the rubber layer 1d becomes 15 or less.

The lightness (L*) is defined in the CIE Lab (L*a*b* color system) color space. When the differences in L* (lightness), a* (hue on the red-green axis), and b* (hue on the yellow-blue axis) between objects are denoted as ΔL*, Δa*, and Δb*, respectively, the color difference is defined as (ΔL*²+Δa*²+Δb*²)^{1/2}. As the color difference increases, visibility tends to improve. In addition, the lightness (L*) may be measured by Personal Image Analysis System (PIAS) manufactured by Quality Engineering Associates (QEA), Inc.

### (2-1-3-2) Rubber Layer Coating Method

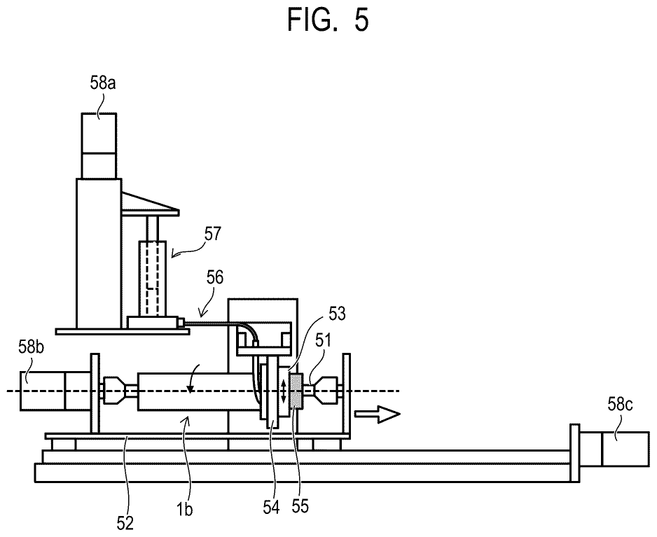

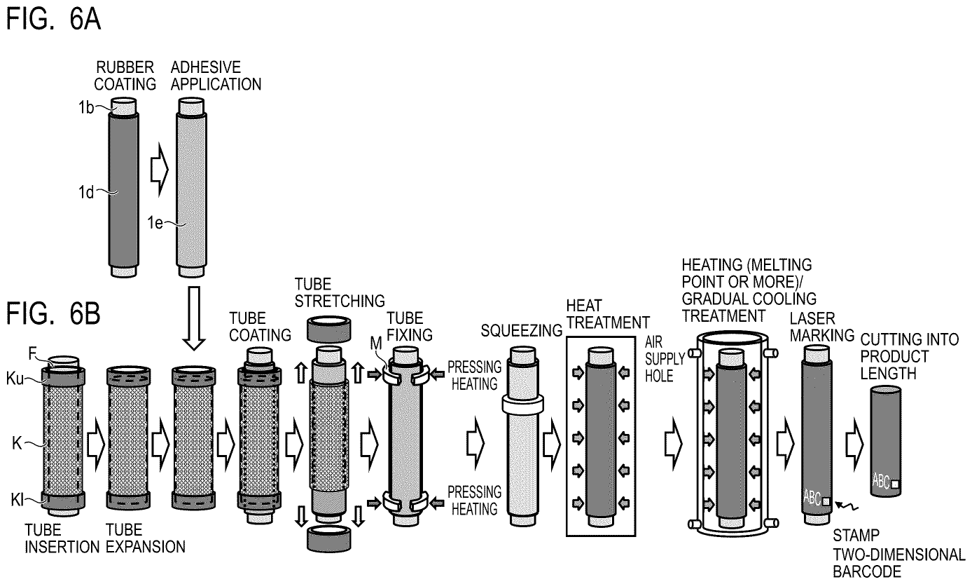

FIG. 5 is a view for illustrating a device for coating the top of the cylindrical base 1b (top of the base) with the silicone rubber elastic layer 1d. In this example, the ring coating method is adopted as the coating method. This step corresponds to the first step in FIG. 6A.

A cylinder pump 57 is filled with an addition-curable silicone rubber composition in which an addition-curable silicone rubber and an inorganic filler are blended, by turning a first motor 58a on. The addition-curable silicone rubber composition filling the pump 57 is pumped toward a coating head 54 through a pressure-feeding tube 56. Then, the addition-curable silicone rubber composition is applied to the outer peripheral surface of the cylindrical base 1b from a coating liquid supply nozzle 53 arranged inside the coating head 54.

The cylindrical base 1b herein is integrated with a cylindrical core metal 51 inserted thereinto. That is, the cylindrical base 1b is rotated by rotating the cylindrical core metal 51 with a second motor 58b in parallel with an operation to supply a coating liquid. Further, the cylindrical base 1b is slid and moved together with the cylindrical core metal 51 to the right (FIG. 5) with a slider 52 by means of a third motor 58c at a constant speed. As a result, the addition-curable silicone rubber composition is applied to the entire region of the cylindrical base 1b to form a coating film.

The thickness of the coating film may be controlled by a clearance between the coating liquid supply nozzle 53 and the cylindrical base 1b, a supply rate of the silicone rubber composition, and a moving speed of the cylindrical base 1b. In this example, the clearance between the coating liquid supply nozzle 53 and the cylindrical base 1b is set to 300 μm, the supply rate of the silicone rubber composition is set to 2.8 mm/s, and the moving speed of the cylindrical base 1b is set to 30 mm/s. Thus, a silicone rubber composition layer 55 of 250 μm is obtained.

The addition-curable silicone rubber composition layer 55 formed on the cylindrical base 1b is heated in an electric furnace for a certain time to advance a cross-linking reaction (curing). Thus, the silicone rubber elastic layer 1d can be formed.

The cylindrical base 1b is desirably subjected to primer treatment (application of an adhesive) in advance in order to improve an adhesive property between the cylindrical base 1b and the silicone rubber elastic layer 1d. A primer (adhesive) used is required to have better wettability with the cylindrical base 1b than the silicone rubber elastic layer 1d. In view of the foregoing, examples of the primer include a hydrosilyl-based (SiH-based) silicone primer, a vinyl-based silicone primer, and an alkoxy-based silicone primer. In this example, a silicone primer is used. The thickness of the primer layer 1c is favorably such a thickness that adhesive performance is exhibited while unevenness is reduced. The thickness is preferably 0.5 μm or more and 5.0 μm or less.

### (2-1-4) Adhesion Layer

The adhesion layer 1e is interposed between the silicone rubber elastic layer 1d and a fluororesin tube, which is a fluororesin layer 1f, and serves to fix the silicone rubber elastic layer 1d and the fluororesin layer 1f to each other.

The adhesion layer 1e is formed by applying an adhesive to the cured silicone rubber elastic layer 1d. This step corresponds to the second step in FIG. 6A.

Then, the rubber layer 1d on which the adhesion layer 1e has been formed is coated with a fluororesin tube F, and by squeezing the adhesive present between the rubber layer 1d and the fluororesin tube F, the thickness of the adhesion layer 1e becomes substantially uniform over the entire region. The squeezing step corresponds to the seventh step in FIG. 6B.

The thickness of the adhesion layer 1e after the squeezing step is preferably set to 3 μm or more and 10 μm or less.

An addition-curable silicone rubber adhesive may be used as the adhesive for forming the adhesion layer 1e. Specifically, the addition-curable silicone rubber adhesive contains an organopolysiloxane having an unsaturated hydrocarbon group typified by a vinyl group, a hydrogen organopolysiloxane, and a platinum compound as a cross-linking catalyst. The adhesive is cured by an addition reaction.

As an adhesive satisfying the conditions described above, an addition-curable silicone rubber adhesive “DOW CORNING® SE 1819 CV A/B (manufactured by Dow Corning Toray Co., Ltd.)” may be used.

### (2-1-5) Fluororesin Layer

In this example, a fluororesin tube is used as the fluororesin layer (release layer) 1f. As a material for the fluororesin tube, a tetrafluoroethylene-perfluoro (alkyl vinyl ether) copolymer (PFA), a polytetrafluoroethylene (PTFE), or a tetrafluoroethylene-hexafluoropropylene copolymer (FEP) is preferably used. In particular, a PFA is preferably used as the material for the fluororesin tube from the viewpoints of moldability and toner releasability.

The thickness of the fluororesin layer 1f is preferably set to 30 μm or less. This is because, when the fluororesin layer 1f is stacked above the rubber layer 1d, elasticity of the underlying rubber layer 1d can be maintained, and surface hardness as the fixing belt 1 can be prevented from excessively increasing. It is preferred that the inner surface of the fluororesin tube be preliminarily subjected to sodium treatment, excimer laser treatment, ammonia treatment, or the like to be improved in adhesive property.

The fluororesin tube may be produced by extruding a molten PFA from a cylindrical die, for example. Such PFA tube is rapidly cooled, and crystallization thereof proceeds rapidly in an extrusion process; thus, crystals are oriented in the extrusion direction, and the degree of crystallinity is in a low state.

A surface of the elastic layer 1d is then coated with the PFA tube to form the release layer 1f, followed by heat treatment at a temperature equal to or higher than the melting temperature of the PFA for forming the release layer 1f. In this manner, the molecular orientation in the PFA tube is relaxed, molecular chains having been oriented in the extrusion direction are randomized, and the thermal conductivity in the thickness direction can thus be improved.

In addition, after completion of the heating, by controlling a cooling rate, the degree of crystallinity can be increased, and spherocrystals can be formed on the surface of the release layer 1f.

The light transmittance (visible light transmittance) of the fluororesin layer 1f is required to be 60% or more. This is because visibility of the mark portion 1L located in an underlying layer is not impaired. The transmittance may be measured by an ultraviolet-visible-near infrared (UV-Vis-NIR) spectrophotometer. In addition, the fact that the light transmittance (visible light transmittance) is 60% or more means that the transmittance is 60% or more in the entire wavelength range of from 380 nm to 750 nm in spectral data obtained.

### (2-1-6) Marking Processing

In this example, in order to form the mark portion 1L that can be visually recognized for, for example, management of the fixing belt 1, marking processing using UV laser light is performed from the release layer 1f side. The marking processing corresponds to the tenth step in FIG. 6B.

When a member in a state in which the elastic layer 1d and the release layer 1f are fixed to each other via the adhesion layer 1e is irradiated with the UV laser light from the release layer 1f side, the UV laser light is transmitted through the release layer 1f and the adhesion layer 1e, and causes a reaction on the surface of the elastic layer 1d. Then, the energy generated at that time propagates to the adhesion layer 1e and the release layer 1f to break the inside of each of the adhesion layer 1e and the release layer 1f, and a void extending from the adhesion layer 1e into the release layer 1f is thus formed. Consequently, a bubble is generated between the release layer 1f and the elastic layer 1d along the character, symbol, two-dimensional barcode, or the like of the mark portion 1L, and visible light transmitted through the release layer 1f is diffusely reflected by the bubble. Thus, a contrast difference between a non-mark portion and the mark portion 1L is increased and visibility is enhanced.

In addition, marking with UV laser light hardly generates heat, and hence irregularities are less liable to occur. Thus, the mark portion 1L with high resolution can be formed.

As a result, even when the elastic layer 1d with low lightness is used, visibility of the mark portion 1L can be ensured.

This example requires no replacement of a consumable component as compared to a marking processing method using a blade or the like, or inkjet-type marking, and is thus excellent in productivity. In addition, unlike a method of marking by scratching an outer surface as in marking with a blade, or a method of marking by ink adhesion as in an inkjet method, a change in visibility along with a change of the outer surface due to rubbing or the like is unlikely to occur. In addition, the inkjet method involves a problem in that a pigment is carbonized at high temperature.

The size of the bubble generated by the laser light may be adjusted by laser output.

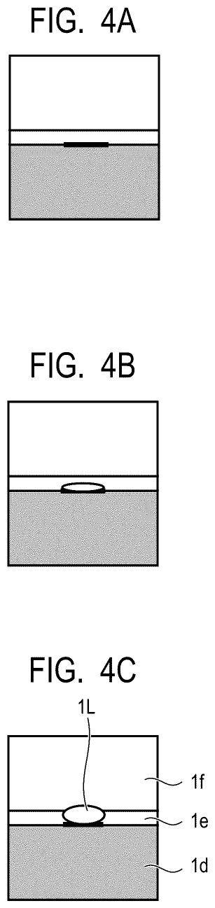

FIG. 4A to FIG. 4C are schematic views for illustrating differences in size of a bubble generated depending on the magnitude of laser output. Among FIG. 4A to FIG. 4C, FIG. 4A is an illustration of a bubble generated with the smallest laser light output, and FIG. 4C is an illustration of a bubble generated with the largest laser light output. In addition, FIG. 4B is an illustration of a bubble generated with laser light output of an intermediate magnitude between that in FIG. 4A and that in FIG. 4C.

As illustrated in FIG. 4A to FIG. 4C, as the laser light output is increased, the size of the bubble increases. As described above, when a member in which the elastic layer 1d, the adhesion layer 1e, and the release layer 1f are laminated is irradiated with laser light from the release layer 1f side, the UV laser light causes a reaction on the surface of the elastic layer 1d (FIG. 4A). When the laser light output is increased, breaking of the adhesion layer 1e due to the reaction energy becomes significant, and the void formed in the adhesion layer 1e also becomes remarkable (FIG. 4B). When the laser light output is further increased, breaking caused by the reaction energy generated on the surface of the elastic layer 1d through irradiation with the laser light extends from the adhesion layer 1e to the release layer 1f (FIG. 4C). Consequently, the adhesion layer 1e is not present between the release layer 1f and an end portion of the bubble generated by breakage on the side opposite to the side in contact with the elastic layer 1d, and the bubble is brought into contact with the release layer 1f.

In the laminated member according to the present disclosure, from the viewpoints of visibility and fineness, it is more preferred that part of the peripheral surface of the bubble be in contact with the release layer 1f as illustrated in FIG. 4C. When the bubble remains inside the adhesion layer 1e, light transmitted through the release layer 1f is absorbed at the surface of the adhesion layer 1e. In contrast, when the adhesion layer 1e is not present between the release layer 1f and an end portion of the bubble on the side opposite to the side in contact with the elastic layer 1d, and part of the peripheral surface of the bubble is in contact with the release layer 1f, light transmitted through the release layer 1f is diffusely reflected by the bubble to enhance contrast, and visibility and fineness are thus improved.

Whether part of the peripheral surface of the bubble is in contact with the release layer 1f may be recognized, for example, by preparing a cross-sectional specimen of the fixing belt and observing the cross-section with a microscope.

In this example, the fixing belt is first cut with a sharp knife, scissors, or the like, and the cross-section thereof is then subjected to polishing processing with an ion milling system (IM-4000, manufactured by Hitachi, Ltd.) to prepare a cross-sectional specimen. A confocal microscope (H1200, manufactured by Lasertec Corporation) is used for observation of the cross-section.

In addition, as another observation method, extension of the bubble to the release layer 1f may be confirmed by measuring the thickness of the release layer 1f at the mark portion 1L and at the non-mark portion with a blue laser displacement meter or the like.

### (3) Fixing Belt Production Process

A method of producing a laminated member having a mark portion visually recognizable from a surface according to the present disclosure is applied to production of the fixing belt. That is, the method of producing a laminated member according to the present disclosure is characterized in that the mark portion is formed by irradiating a laminated member before processing with laser light from the surface layer side to form a bubble between the base layer and the surface layer. The laminated member before processing herein is a member in which a base layer having a lightness of 15 or less, an adhesion layer, and a surface layer having a visible light transmittance of 60% or more are laminated in this order.

FIG. 6A and FIG. 6B are views for illustrating a flow of producing the fixing belt. The two steps illustrated in FIG. 6A represent steps from coating with the rubber layer 1d to application of the adhesive, and the 11 steps illustrated in FIG. 6B represent steps from coating with the fluororesin tube F to cutting into a product length.

The two steps in FIG. 6A are as described above. The 11 steps in FIG. 6B are described in detail below. In this example, a method (expansion coating method) for coating the rubber layer 1d from the outside with the fluororesin tube F in an expanded state is used.

In the first step in FIG. 6B, the fluororesin tube F is arranged in a metal expansion mold K having an inner diameter larger than the outer diameter of the cylindrical base 1b on which the rubber layer 1d is stacked, and both longitudinal ends of the fluororesin tube F are held by using holding members Ku and Kl.

In the second step, a gap portion between the outer surface of the fluororesin tube F and the inner surface of the expansion mold K is evacuated to a vacuum state (negative pressure relative to atmospheric pressure). As the vacuum state (5 kPa) is established, the fluororesin tube Fis expanded in the radial direction, and the outer surface of the fluororesin tube F comes into close contact with the inner surface of the expansion mold K.

In the third step, an intermediate product formed in the two steps in FIG. 6A, that is, the cylindrical base 1b on which the rubber layer 1d is stacked is inserted into the expansion mold K. The addition-curable silicone rubber adhesive is uniformly applied to the outer surface of the rubber layer 1d.

In the fourth step, after the cylindrical base 1b on which the rubber layer 1d is stacked is arranged inside the expanded fluororesin tube F, the vacuum state (negative pressure relative to atmospheric pressure) of the gap portion between the outer surface of the fluororesin tube F and the inner surface of the expansion mold K is released.

As the vacuum state is released, expansion of the fluororesin tube F is relaxed to substantially the same size as the outer diameter of the cylindrical base 1b on which the rubber layer 1d is stacked, and the fluororesin tube F and the rubber layer 1d come into close contact with each other.

In the fifth step, the fluororesin tube F is stretched in the longitudinal direction thereof until a predetermined stretching rate is achieved.

When the fluororesin tube F is stretched, the adhesive interposed between the fluororesin tube F and the rubber layer 1d serves as a lubricant, and the fluororesin tube F can be smoothly stretched. The stretching rate of the fluororesin tube F in the longitudinal direction may be set to, for example, 8%.

In this manner, by stretching the fluororesin tube F in the longitudinal direction, wrinkles hardly occur on the fluororesin tube during use in the fixing device, and a fixing belt with high durability can be obtained.

In the sixth step, force to return to the original length acts on the fluororesin tube F, and hence the fluororesin tube F is temporarily fixed by heating the fluororesin tube F from the outside with a metal block M including a heater while pressing the tube. The temperature of the metal block M during the pressing heating is set to, for example, 200° C., and the pressing heating time is set to, for example, 20 seconds.

In the seventh step, an excess amount of the lubricant interposed between the rubber layer 1d and the fluororesin layer 1f is squeezed out. Through this squeezing step, the thickness X (FIG. 3) of the adhesion layer 1e is adjusted to fall within the range of 3 μm or more and 10 μm or less, for example.

In the eighth step, heating is performed over a predetermined time in an electric furnace. As a result, the adhesive is cured to form the adhesion layer 1e.

In the ninth step, heating treatment at a temperature equal to or higher than the melting temperature of the PFA, which is a material for the release layer 1f, is conducted to relax molecular orientation of the PFA tube, and molecular chains having been oriented in the extrusion direction are randomly oriented to improve the thermal conductivity in the thickness direction. At this time, in order to heat the entire region of the fixing member, an upright and cylindrical heating tube allowing heating to 330° C. or more is used, for example. A band heater to which a thermocouple is mounted is installed inside the heating tube, and temperature for heating the fixing member is controlled.

In addition, after completion of the heating, by controlling a rate for cooling the heating tube, a rate for cooling the fixing member is controlled, and the degree of crystallinity can thus be increased. For example, an air supply nozzle is provided on an outer periphery of the heating tube, and the cooling rate can be controlled by adjusting the air flow rate.

In the subsequent marking step, UV laser light is applied from the release layer 1f side toward the elastic layer 1d. In this step, the UV laser light is transmitted through the release layer 1f and the adhesion layer 1e, and causes a reaction on the surface of the elastic layer 1d. The energy generated at that time propagates to the adhesion layer 1e and release layer 1f side to break each of the adhesion layer 1e and the release layer 1f, and a void extending from the adhesion layer 1e into the release layer 1f is thus formed. Consequently, a bubble is generated between the release layer 1f and the elastic layer 1d along the character, symbol, two-dimensional barcode, or the like of the mark portion, and visible light transmitted through the release layer 1f is diffusely reflected by the bubble. Thus, a contrast difference between a non-mark portion and the mark portion 1L is increased and visibility is enhanced.

In the last step, the fixing belt 1 is cut into a desired length.

Through the steps described above, the fixing belt 1 is produced.

### EXAMPLES

Effects of the present disclosure are described below by way of Examples and Comparative Examples.

### Example 1

### (1) Preparation of Liquid Addition-Curable Silicone Rubber Composition

First, as the component (a), 98.6 parts by mass of a silicone polymer having a vinyl group, which was an unsaturated aliphatic group, only at each of both the terminals of the molecular chain thereof and having, as an unsubstituted hydrocarbon group free of any other unsaturated aliphatic group, a methyl group was prepared. This silicone polymer (product name: DMS-V35, manufactured by Gelest, Inc., viscosity: 5,000 mm²/s) is hereinafter referred to as “Vi”.

Next, 170 parts by mass of metal silicon (product name: #350, manufactured by KINSEI MATEC CO., LTD.) was added as a thermally conductive filler to the Vi, followed by thorough mixing to provide a mixture 1.

Next, as the component (d), a solution obtained by dissolving 0.2 part by mass of 1-ethynyl-1-cyclohexanol (manufactured by Tokyo Chemical Industry Co., Ltd.), which was a curing retarder, in the same mass of toluene was added to the mixture 1 to provide a mixture 2.

Next, as the component (c), 0.1 part by mass of a hydrosilylation catalyst (platinum catalyst: a mixture of 1,3-divinyltetramethyldisiloxane platinum complex, 1,3-divinyltetramethyldisiloxane, and 2-propanol) was added to the mixture 2 to provide a mixture 3.

Further, as the component (b), 1.5 parts by mass of a silicone polymer (product name: HMS-301, manufactured by Gelest, Inc., viscosity: 30 mm²/s, hereinafter referred to as “SiH”) having a siloxane skeleton in a linear form and having an active hydrogen group bonded to silicon only in a side chain was weighed. This silicone polymer was added to the mixture 3, followed by thorough mixing to provide a liquid addition-curable silicone rubber composition.

### (2) Production of Fixing Belt

As a polyimide precursor solution, an N-methyl-2-pyrrolidone solution of a polyimide precursor formed of 3,3′,4,4′-biphenyltetracarboxylic dianhydride and p-phenylenediamine was prepared. The inner surface of the cylindrical base 1b, which was formed of stainless steel (SUS) and had an inner diameter of $24 mm, a thickness of 30 μm, and a length of 400 mm was coated with this precursor solution, followed by firing at 200° C. over 20 minutes for imidization to form the inner surface sliding layer 1a having a thickness of 15 μm.

A primer (product name: DY39-051 A/B, manufactured by Dow Corning Toray Co., Ltd.) was substantially uniformly applied to the outer peripheral surface of the cylindrical base 1b so that its dry weight was 20 mg. After that, the solvent was dried, and then baking treatment was performed in an electric furnace set at 160° C. for 30 minutes to form the primer layer 1c.

The above-mentioned silicone rubber composition was applied onto the base after the primer treatment by a ring coating method so that its thickness was 250 μm. The obtained product is referred to as “uncured endless belt.”

The uncured endless belt was heated in an electric furnace at 160° C. for 1 minute (primary curing) and then heated in an electric furnace at 200° C. for 30 minutes (secondary curing) so that the silicone rubber composition was cured. Thus, a cured endless belt including the elastic layer 1d was obtained. The lightness of the elastic layer 1d at this time was 15.

Next, an addition-curable silicone rubber adhesive (product name: SE1819CV A/B, manufactured by Dow Corning Toray Co., Ltd.) was substantially uniformly applied as the adhesion layer 1e to the surface of the elastic layer 1d of the cured endless belt so that its thickness was about 10 μm. As the release layer 1f, a PFA (product name: AP-231SH, manufactured by DAIKIN INDUSTRIES, LTD.) was extrusion-molded so as to achieve an inner diameter of 23 mm and a thickness of 20 μm, and was laminated while the fluororesin tube F having been subjected to inner surface etching was expanded. The visible light transmittance of the PFA tube used in this case was 60%.

After that, by uniformly squeezing the belt surface over the fluororesin tube F, an excessive amount of the adhesive was squeezed out from between the elastic layer 1d and the fluororesin tube F so as to reduce the thickness of the adhesive to about 5 μm.

This endless belt was heated in an electric furnace set at 200° C. for 1 hour so that the adhesive was cured. Thus, the fluororesin tube was fixed onto the elastic layer 1d.

The obtained endless belt was inserted into a heating tube having an inner diameter of φ42 mm, and subjected to heating treatment with a band heater inside the heating tube. The controlled heating temperature for the end portion of the fixing member was set to 330° C., and heating was controlled so that the actual temperature of the release layer 1f was equal to or higher than the melting temperature of the PFA.

The heating time was set to 3 minutes from placement of the fixing film into the heating tube, as a time sufficient for the actual temperature of the release layer 1f to reach a desired temperature.

After 3 minutes had elapsed from the placement, the heating tube was cooled to 200° C. at a rate of 20° C./min, and then removed from the heating tube into a normal temperature atmosphere. Thus, an endless belt having the release layer 1f with an increased degree of crystallinity was obtained.

After that, the endless belt was irradiated with UV laser light by using MD-U1000C manufactured by KEYENCE CORPORATION to perform marking. As irradiation conditions, the laser output was set to 90% and the working distance (WD) was set to 25 mm. In addition, a character string (Lot: ABC) was marked with a size of 1 mm×2 mm per character, and a two-dimensional barcode was marked with a size of 3 mm×3 mm.

Finally, both end portions of the endless belt after the marking were cut. Thus, a fixing belt with a width of 336.5 mm was obtained.

### (3) Evaluation of Marking

It was recognized that the two-dimensional barcode (3 mm×3 mm) of the formed mark portion was able to be read with a barcode reader (BT-W250, manufactured by KEYENCE CORPORATION), and a reading rate was calculated from the number of times the barcode was successfully read out of 20 scans. In addition, visibility of the mark portion was ranked according to the following criteria.
A: The characters and numerals described can be immediately recognized.
B: The characters and numerals described can be recognized, but resolution is poor; alternatively, the contrast difference is small, and the characters and numerals are difficult to see.
C: The lines of the characters and numerals are blurred, and resolution is poor; alternatively, the contrast difference is small, and the characters and numerals cannot be recognized by visual observation.

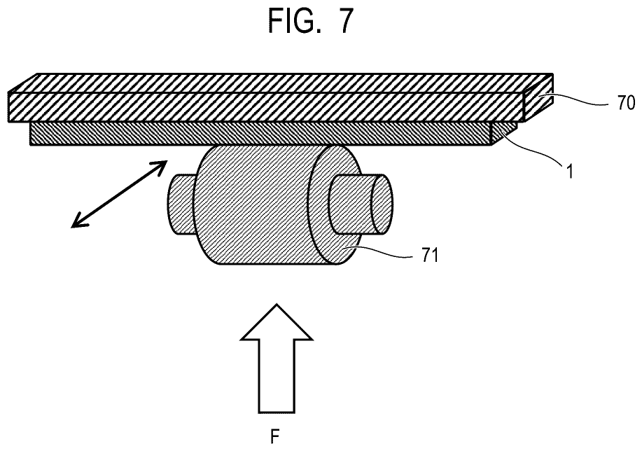

In addition, durability of the mark portion 1L was evaluated. FIG. 7 is a schematic view for describing a method of evaluating the durability of the mark portion 1L. A sample cut out from the fixing belt 1 and fixed was prepared on a stainless-steel sheet 70 with a size of 50 mm×50 mm, and pressure resistance durability was evaluated. A pressure durability test was conducted under the evaluation conditions of a sample surface temperature of 240° C. and a load F of 10 N by reciprocally moving a pressing roller 71 (width: 10 mm, diameter: 15 mm) in a direction indicated by the arrow in FIG. 7 for 10 hours. In the evaluation of the pressure resistance durability, a case in which the mark portion 1L did not disappear after the test was ranked as “A”, and a case in which the mark portion 1L had disappeared was ranked as “C”.

### Example 2

A fixing belt was obtained in the same manner as in Example 1 except that the laser output in the marking step was changed to 60%.

### Example 3

A fixing belt was obtained in the same manner as in Example 1 except that the thickness of the fluororesin tube was changed to 50 μm.

### Comparative Example 1

A fixing belt was obtained in the same manner as in Example 1 except that the laser output in the marking step was changed to 20%.

### Comparative Example 2

The marking step was executed by using an inkjet printer (inkjet printer MK-G manufactured by KEYENCE CORPORATION) instead of the UV laser light.

### Comparative Example 3

A fixing belt was obtained in the same manner as in Example 1 except that UV laser light irradiation was conducted after forming the elastic layer instead of conducting UV laser light irradiation after forming the release layer in the marking step.

### Comparative Example 4

A fixing belt was obtained in the same manner as in Example 1 except that a fluororesin tube with a low visible light transmittance to which silica (Tospearl manufactured by Momentive) was added was used as the fluororesin tube.

### Comparative Example 5

A fixing belt was obtained in the same manner as in Example 1 except that 50 parts of magnesium oxide (STARMAG manufactured by Konoshima Chemical Co., Ltd.) was added in addition to metal silicon as the filler incorporated into the elastic layer.

The evaluation results are summarized in Table 1 below.

TABLE 1

| | | Surface layer | | | | | |
|---|---|---|---|---|---|---|---|
| | Elastic layer | Visible light | Marking | Mark portion | | Barcode | Mark portion |
| | Lightness | transmittance | method | bubble | Visibility | reading rate | durability |
| Example 1 | 15 or less | 70% to 80% | Laser from | In contact | A | 100% | A |
| | | | surface layer | with surface | | | |
| | | | side | layer | | | |
| Example 2 | 15 or less | 70% to 80% | Laser from | Not in contact | A | 80% | A |
| | | | surface layer | with surface | | | |
| | | | side | layer | | | |
| Example 3 | 15 or less | 60% to 65% | Laser from | In contact | A | 95% | A |
| | | | surface layer | with surface | | | |
| | | | side | layer | | | |
| Comparative | 15 or less | 70% to 80% | Laser from | Absent | C | 20% | A |
| Example 1 | | | surface layer | | | | |
| | | | side | | | | |
| Comparative | 15 or less | 70% to 80% | Inkjet from | Absent | B | 60% | C |
| Example 2 | | | surface layer | | | | |
| | | | side | | | | |
| Comparative | 15 or less | 70% to 80% | Laser after | Absent | B | 40% | A |
| Example 3 | | | elastic layer | | | | |
| | | | formation | | | | |
| Comparative | 15 or less | 40% to 55% | Laser from | In contact | B | 60% | A |
| Example 4 | | | surface layer | with surface | | | |
| | | | side | layer | | | |
| Comparative | 20 to 30 | 70% to 80% | Laser from | Absent | B | 60% | A |
| Example 5 | | | surface layer | | | | |
| | | | side | | | | |

As shown in Table 1, in each of Examples 1 to 3, the mark portion 1L appeared lighter (high contrast) than the surroundings, and favorable visibility was exhibited. In addition, excellent durability of the mark portion was also recognized. In particular, in each of Examples 1 and 3, in which part of the peripheral surface of a bubble was in contact with the surface layer, favorable visibility was exhibited, and the barcode reading success rate was high.

In contrast, in each of Comparative Examples 1 to 5, the mark portion 1L did not appear lighter (low contrast) than the surroundings, and visibility was poor. In addition, in Comparative Example 2, the mark portion disappeared quickly upon rubbing.

Examples demonstrated in these examples were able to provide a laminated member in which the visibility of the mark portion 1L was favorable, and a method of producing the same.

According to the present disclosure, a laminated member in which both the visibility and resolution of a mark portion are favorable, a method of producing the laminated member, and an electrophotographic member in which both the visibility and resolution of a mark portion are favorable can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-206477, filed Nov. 27, 2024, which is hereby incorporated by reference herein in its entirety.

What is claimed is:

1. A laminated member comprising a base layer, an adhesion layer, and a surface layer laminated in this order,
wherein the base layer has a lightness of 15 or less,
wherein the surface layer has a visible light transmittance of 60% or more, and
wherein a bubble is present between the surface layer and the base layer, and the bubble forms a mark portion visually recognizable from a surface of the laminated member.

2. The laminated member according to claim 1, wherein part of a peripheral surface of the bubble is in contact with the surface layer.

3. A method of producing a laminated member having a mark portion visually recognizable from a surface, the method comprising
irradiating a laminated member before processing, in which a base layer having a lightness of 15 or less, an adhesion layer, and a surface layer having a visible light transmittance of 60% or more are laminated in this order, with laser light from a surface layer side to generate a bubble between the base layer and the surface layer, to thereby form the mark portion.

4. An electrophotographic member having a cylindrical shape, the electrophotographic member comprising a laminated structure in which an elastic layer, an adhesion layer, and a surface layer are laminated in this order,
wherein the elastic layer has a lightness of 15 or less,
wherein the surface layer has a visible light transmittance of 60% or more, and
wherein a bubble is present between the surface layer and the elastic layer, and the bubble forms a mark portion visually recognizable from a surface of the laminated structure.

5. The electrophotographic member according to claim 4, wherein part of a peripheral surface of the bubble is in contact with the surface layer.
